(19) United States
(12) Patent Application Publication
(10) Pub. No.: US 2009/0072783 A1
(43) Pub. Date: Mar. 19, 2009

(54) Inductively charged vapor-emitting device

(75) Inventors: Ryan M. Gaspar, Cave Creek, AZ (US); Jeffrey Bankers, Phoenix, AZ (US)

Correspondence Address: THE DIAL CORPORATION, 19001 N. Scottsdale Road, SCOTTSDALE, AZ, 85255, US

(73) Assignee: The Dial Corporation

(21) Appl. No.: 11/901,742

(22) Filed: Sep. 18, 2007

(51) Int. Cl. H02J 7/00

(52) U.S. Cl. 320/108

(57) ABSTRACT

An inductively charged vapor-emitting device for dispensing a volatizable material into the surrounding environment is described. The inductively charged vapor-emitting device includes an inductive coil including a magnetic core mounted in a housing and coupled to at least one rechargeable power source mounted within the housing. The inductive coil configured to inductively receive electric power from a remote power source to recharge the at least one rechargeable power source.

### FIELD OF INVENTION

The present invention relates to vapor-emitting devices, and more particularly to, a battery powered vapor-emitting device, wherein the device includes a means for inductively charging the batteries.

### BACKGROUND

Vapor-emitting devices are generally used to emit an environment-altering fragrance, an insect repellant, and/or the like into the atmosphere. In general, a vapor-emitting device operates by releasing a fragrance or other volatizable active ingredient into the atmosphere. This process occurs through vaporization and/or evaporation over an extended time period. The vapor-emitting device may provide, amongst other things, the automated release of a pleasing fragrance or a material to counter offensive odors into the atmosphere. Current and future vapor-emitting devices are relying more heavily on self-contained power sources, such as batteries, to power the operation than previous devices. In some instances, standard disposable batteries are included, but it is becoming more common to incorporate rechargeable batteries into the vapor-emitting devices that may prove more cost effective.

There are, however, at least a few problems associated with such battery powered vapor-emitting devices, one of the most critical being that upon depletion of the battery energy, the batteries must be replaced, or in the instance of rechargeable batteries, they must be recharged. Often times the recharging of the batteries has proven to be a consumer hurdle as they occasionally require either plugging the device into a standard charger, or removing the batteries and charging them separately from the device.

As described above, current devices do not include a means for recharging of a battery powered vapor-emitting device without the need to plug the device into a power source, remove the batteries for recharging, or simply replacing the batteries. Accordingly, there is a need for a vapor-emitting device that includes a means for recharging of a rechargeable power source that is incorporated into the vapor-emitting device without the need to plug the device into a power source, or disassemble the device for removal or replacement of the power source.

It should thus be appreciated from the above that it would be desirable to provide a vapor-emitting device that incorporates a rechargeable power source and a means for easily recharging the power source. Furthermore, other desirable features and characteristics of the present invention will become apparent from the subsequent detailed description of the invention and the appended claims, taken in conjunction with the accompanying drawings and this background of the invention.

### SUMMARY OF THE INVENTION

There has now been developed an inductively charged vapor-emitting device for dispensing a volatizable material into a surrounding environment according to an exemplary embodiment of the present invention. The dispensing device is comprised of a housing, a rechargeable power source, and a first inductive coil. The housing has contained therein a volatizable material. The rechargeable power source is positioned within the housing and configured to actuate and disperse the volatizable material. The first inductive coil is positioned within the housing and coupled to the rechargeable power source. The first inductive coil when positioned proximate a second inductive coil connected to a separate power source unit, inductively receives electric power from the second inductive coil for recharging of the rechargeable power source.

In yet another embodiment, by way of example only, there is provided an inductively charged vapor-emitting device for dispensing a volatizable material into a surrounding environment comprising a housing, a volatizable material contained in the housing, a rechargeable power source mounted in the housing and configured to aid in dispersing the volatizable material, a first inductive coil mounted in the housing and coupled to the rechargeable power source, a magnetic core inserted into the first inductive coil, and a converter mounted in the housing and coupled to the first inductive coil. The first inductive coil when positioned proximate a second inductive coil housed in a separate power source unit, inductively receives electric power from the second inductive coil for recharging of the rechargeable power source.

In a further embodiment, still by way of example only, there is provided an inductively charged vapor-emitting device for dispensing a volatizable material into a surrounding environment comprising a housing, a volatizable material contained in the housing, at least one rechargeable battery mounted in the housing and configured to actuate the dispersing of the volatizable material. A first inductive coil including a magnetic core is mounted in the housing and coupled to the at least one rechargeable battery. The first inductive coil is configured to inductively receive electric power from a remote power source. The device further includes a converter mounted in the housing and coupled to the first inductive coil to convert the energy inductively received by the first conductive coil to a direct current (DC) voltage supply for charging the at least one rechargeable battery.

Other independent features and advantages of the inductively charged vapor-emitting device will become apparent from the following detailed description, taken in conjunction with the accompanying drawings which illustrate, by way of example, the principles of the invention.

### BRIEF DESCRIPTION OF THE DRAWINGS

The present invention will hereinafter be described in conjunction with the following drawing FIGs., wherein like numerals denote like elements. Additional embodiments of the invention will become evident upon reviewing the non-limiting embodiments described in the specification in conjunction with the accompanying FIG.s, wherein:

FIG. 1 illustrates a preferred embodiment of the inductively charged vapor emitting device in communication with a power source unit; and

FIG. 2 illustrates the basic structure of the inductively charged vapor emitting device and power source unit of FIG. 1.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention. In this regard, before proceeding with the detailed description, it is to be appreciated that the described exemplary embodiment is not limited to use in conjunction with a specific type or vapor-emitting device, nor a specific type of device design. Thus, although the description is explicitly directed toward a specific embodiment of a vapor-emitting device for use with an remote charger, it should be appreciated that the device may come in varying designs and can be implemented to contain and emit many types of actives such as fragrances, repellants, or the like, including those known now or hereafter in the art.

The detailed description of exemplary embodiments of the invention herein makes reference to the accompanying FIGs. which show the exemplary embodiment by way of illustration and its best mode. While the exemplary embodiment is described in sufficient detail to enable one skilled in the art to practice the invention, it should be understood that other embodiments may be realized, and that logical and/or mechanical changes may be made without departing from the spirit and scope of the invention. Thus, the detailed description herein is presented for purposes of illustration only and not by way of limitation.

The present invention relates to an inductively charged device comprising a vapor emitting device that includes a rechargeable power source, such as a battery or batteries, configured for inductive charging from a separately formed power source unit. The device of the present invention may find utility within both the residential consumer and commercial markets.

The present invention relates to a device that minimally comprises: (a) a device unit, and more particularly a vapor-emitting device including a means for dispensing a volatizable material contained therein; (b) a rechargeable power source contained within the vapor-emitting device; and (c) a first inductive coil contained within the vapor-emitting device and forming a first portion of a transformer. The first inductive coil is configured to inductively receive electric power from a second inductive coil positioned in a power source unit for recharging of the rechargeable power source. The volatizable material contained within the vapor-emitting device may comprise any physical form, (e.g. thin liquid solution, thick liquid mixture, oil, emulsions, suspensions, solids, waxes, semi-solids, gels, beads, coated granules, etc.), and may consist of a pure single chemical entity or a mixture of chemical entities.

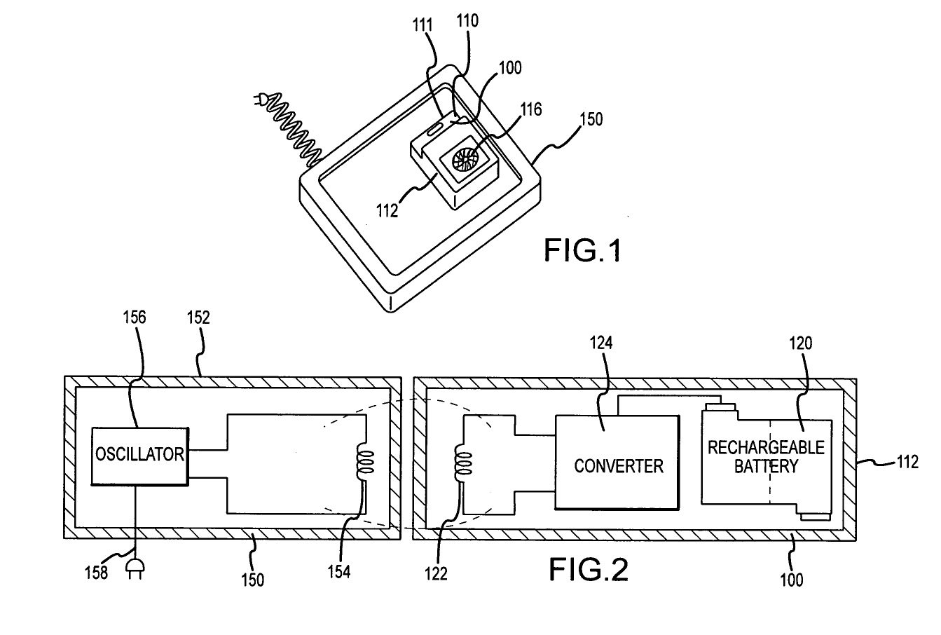

Referring now to FIG. 1, the size of the overall dispensing device 100 of the present invention may be any size practical to maintain function, and the conceptual diagram of FIG. 1 is not intended to connote any particular physical size. It may be miniaturized, just a few inches in height and width, or the device may be quite large. A smaller dimensioned device may be used in devices sold to the typical residential consumer, whereas a large unit may be used in institutional and industrial type settings to disperse large amounts of volatizable material into the surrounding atmosphere. The example thus given is not intended to be limiting but is instead listed to give a taste of the useful scope of the present invention.

Now referring to the device depicted in FIG. 1, illustrated is an exemplary embodiment of an inductively charged vapor-emitting device 100 positioned relative to a power source unit 150. The inductively charged vapor-emitting device 100 may be any device and/or components known in the art capable of dispensing a volatizable ingredient (e.g., a fragrance, insecticide, insect repellant, and the like). In this exemplary embodiment, the inductively charged vapor-emitting device 100 includes a reservoir 110, having contained therein a volatizable material 111 including an active or volatizable ingredient. The inductively charged vapor-emitting device 100 is operable as an active vapor-emitting device such that the volatizable material 111 is caused to be dispensed at a given time rather than passively evaporating.

The inductively charged vapor-emitting device 100 includes a housing 112, for containing therein the volatizable material 111 and associated dispensing control electronics (not shown). In the embodiment illustrated in FIG. 1, the inductively charged vapor-emitting device 100 includes an optional fan mechanism 116 to aid in the disbursement of the volatizable material 111 wherein the fan mechanism 116 is powered by the inductively charged power source (discussed presently). It should be anticipated that in an alternative embodiment, the vapor-emitting device 100 may be configured as a passive, or evaporative, device wherein the volatizable material 111 evaporates and the fan mechanism 116 is included to aid in the disbursement of the volatizable material 111. In addition, in further alternative embodiments the vapor-emitting device 100 may be configured to deliver the volatizable material 111 via a piezoelectric delivery, electrospray, automated aerosol release, resistive heating, or any other type of predictive delivery system that may be powered by the included inductively charged power source (described presently). Furthermore, the vapor-emitting device 100 may further include any number of ancillary portions with benefits such as sensors (light/motion/odor) that may be powered by the included inductively charged power source.

The volatizable material 111 may include any volatizable ingredient known in the art capable of, for example, altering the scent in an environment (e.g., a fragrance) and/or discouraging insects and the like from being present in the environment (e.g., an insecticide, an insect repellant, and the like). In this exemplary embodiment, the volatizable material 110 is an air treatment device and includes a fragrance. The volatizable materials 111 to which the present invention applies are well known in the art, as are the methods of manufacture and positioning in a housing such as housing 112 shown in FIG. 1. It should be understood that although the housing 112 is disclosed as being generally rectangular in shape, alternative shapes for the housing 112 are anticipated by this disclosure. In a preferred embodiment, the housing 112 is formed of a molded plastic material, although other suitable materials are anticipated by this disclosure.

Now referring to the individual components schematically depicted in FIG. 2, the inductively charged vapor-emitting device 100 partially comprises the housing 112 having disposed therein a plurality of rechargeable batteries 120 which serve as the power source. The inductively charged vapor-emitting device 110 further has disposed therein a primary coil 122. A magnetic core 124 of a ferromagnetic material of high magnetic permeability, e.g., ferrite, is inserted through the primary coil 122. The power source unit 150 includes within a housing 152, a secondary coil 154 and an oscillator 156 for feeding an alternating current power supplied from a commercial alternating current power source via a coupling 158, to the secondary coil 154. When the vapor-emitting device 100 and the power source unit 150 are placed in contact with each other, the primary coil 122 and the secondary coil 154 are coupled through electromagnetic induction

More specifically, when the vapor-emitting device 100 and the power source unit 150 are in contact, the primary and secondary coils 122 and 154 are positioned in close proximity to each other. Thus, the coils 122 and 154 are electromagnetically induced and coupled with each other. This coupling produces a predetermined power that is supplied to the rechargeable batteries 120 of the vapor-emitting device 100 from the power source unit 150 via electromagnetic induction. The recharging of the batteries 120 uses the principle of electromagnetic induction to transfer power wirelessly via an electromagnetic field from the power source unit 150 that serves as a charging base to the vapor-emitting device 100 that serves as a power receiver.

During the charging process, a power supply provides an alternating current (AC) voltage supply for energizing the secondary coil 154. It should be understood that although an AC current is described herein, a direct current (DC) voltage supply may be used and inverted to produce and AC voltage supply in some instances. When the inductively chargeable vapor-emitting device 100 is properly positioned proximate the power source unit 150, vector components of an energy field of the transmitting secondary coil 154 and vector components of an energy field of the absorbing first inductive coil are aligned for energy transfer. The secondary coil 154 generates an electromagnetic field and induces an electrical charge on the primary coil 122 within the inductively chargeable vapor-emitting device 100. The inductively received energy in the primary coil 122 is then converted, such as by a converter 124 positioned within housing 112, to a DC voltage supply for charging the rechargeable battery or batteries 120.

We have thus described a unique and new invention that comprises an inductively chargeable vapor emitting device that includes therein at least a volatizable material configured for disbursement into the surrounding environment. The device of the present invention includes a power source in the form of a rechargeable battery, or batteries, or the like, that may be inductively charged. To achieve inductive charging of the vapor emitting device, the device further includes an inductive coil, and when positioned proximate a power source unit that includes a second inductive coil, recharges using electromagnetic induction principles.

The features disclosed in the foregoing description, in the claims and/or in the accompanying drawings may, both separately and in any combination thereof, be material for realizing the invention in diverse forms thereof. Accordingly, disclosed is an improved vapor-emitting device for dispensing a volatizable material into the surrounding environment that is capable of being recharged using electromagnetic inductive principles and a power source until. While exemplary embodiments have been presented in the foregoing detailed description of the invention, it should be appreciated that a vast number of variations exist. In addition, benefits, other advantages, and solutions to the problem have been described herein with regard to exemplary embodiments. However, the benefits, advantages, solutions to problems, and any element(s) that may cause any benefit, advantage, or solution to occur or become more pronounced are not to be construed as critical, required, or essential features or elements of any or all the claims or the invention. It should also be appreciated that the exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims, in which reference to an element in the singular is not intended to mean “one and only one” unless explicitly so stated, but rather “one or more.” All structural, chemical, and functional equivalents to the elements of the above-described exemplary embodiments that are known to those of ordinary skill in the art are expressly incorporated herein by reference and are intended to be encompassed by the present claims.

We claim:

1. An inductively charged vapor-emitting device for dispensing a volatizable material into a surrounding environment comprising:
a housing having contained therein a volatizable material;
a rechargeable power source positioned within the housing and configured to actuate and disperse the volatizable material; and
a first inductive coil positioned within the housing and coupled to the rechargeable power source,
wherein the first inductive coil when positioned proximate a second inductive coil connected to a separate power source unit, inductively receives electric power from the second inductive coil for recharging of the rechargeable power source.

2. A dispensing device as claimed in claim 1, wherein the second inductive coil generates an electromagnetic field for inducing an electrical charge on the first inductive coil.

3. A dispensing device as claimed in claim 2, wherein the energy induced on the first conductive coil is converted to a DC voltage supply for charging the rechargeable power source.

4. A dispensing device as claimed in claim 1, wherein the first inductive coil forms a portion of a transformer

5. A dispensing device as claimed in claim 1, further comprising a magnetic core inserted in the first inductive coil.

6. A dispensing device as claimed in claim 1, wherein the vapor-emitting device is an air treatment device.

7. A dispensing device as claimed in claim 1, wherein the vapor-emitting device is operable to dispense the volatizable material from within the vessel in response to a battery operated actuation system.

8. A dispensing device as claimed in claim 1, wherein the volatizable material is comprised of at least one volatizable fragrance material.

9. An inductively charged vapor-emitting device for dispensing a volatizable material into a surrounding environment comprising:
a housing;
a volatizable material contained in the housing;
a rechargeable power source mounted in the housing and configured to aid in dispersing the volatizable material;
a first inductive coil mounted in the housing and coupled to the rechargeable power source;
a magnetic core inserted into the first inductive coil; and
a converter mounted in the housing and coupled to the first inductive coil;
wherein the first inductive coil when positioned proximate a second inductive coil housed in a separate power source unit, inductively receives electric power from the second inductive coil for recharging of the rechargeable power source.

10. A dispensing device as claimed in claim 9, further comprising a fan mounted in the housing and configured to actuate to disperse the volatizable material.

11. A dispensing device as claimed in claim 9, further comprising a piezoelectric delivery system mounted in the housing and configured to actuate to disperse the volatizable material.

12. A dispensing device as claimed in claim 9, further comprising an electrospray delivery system mounted in the housing and configured to actuate to disperse the volatizable material.

13. A dispensing device as claimed in claim 9, further comprising an automated electrospray delivery system mounted in the housing and configured to actuate to disperse the volatizable material.

14. A dispensing device as claimed in claim 9, further comprising a resistive heating delivery system mounted in the housing and configured to actuate to disperse the volatizable material.

15. A dispensing device as claimed in claim 9, further including ancillary portions powered by the rechargeable power source.

16. A dispensing device as claimed in claim 9, wherein the second inductive coil generates an electromagnetic field for inducing an electrical charge on the first inductive coil.

17. A dispensing device as claimed in claim 16, wherein the energy induced on the first conductive coil is converted to a DC voltage supply for charging the rechargeable power source.

18. A dispensing device as claimed in claim 16, wherein the converter converts the energy inductively received by the first conductive coil.

19. A dispensing device as claimed in claim 9, wherein the vapor-emitting device is an air treatment device.

20. A dispensing device as claimed in claim 9, wherein the vapor-emitting device is operable to dispense the volatizable material from within the vessel in response to a battery operated actuation system.

21. A dispensing device as claimed in claim 9, wherein the volatizable material is comprised of at least one volatizable fragrance material.

22. An inductively charged vapor-emitting device for dispensing a volatizable material into a surrounding environment comprising:
a housing;
a volatizable material contained in the housing;
at least one rechargeable battery mounted in the housing and configured to actuate the dispersing of the volatizable material;
a first inductive coil including a magnetic core mounted in the housing and coupled to the at least one rechargeable battery, the first inductive coil configured to inductively receive electric power from a remote power source;
a converter mounted in the housing and coupled to the first inductive coil to convert the energy inductively received by the first conductive coil to a direct current (DC) voltage supply for charging the at least one rechargeable battery.

23. A dispensing device as claimed in claim 22, wherein the vapor-emitting device is an air treatment device.

24. A dispensing device as claimed in claim 22, wherein the vapor-emitting device is operable to dispense the volatizable material from within the vessel in response to a battery operated actuation system.
